(19) United States
(12) Patent Application Publication
(10) Pub. No.: US 2012/0082919 A1
(43) Pub. Date: Apr. 5, 2012

(54) POLYMER ELECTROLYTE FUEL CELL

(76) Inventors: Atsuhiko ONUMA, Hitachi (JP); Makoto Morishima, Hitachinaka (JP)

(21) Appl. No.: 13/222,445

(22) Filed: Aug. 31, 2011

(30) Foreign Application Priority Data
Sep. 30, 2010 (JP) 2010-220195

(51) Int. Cl. H01M 8/10

(52) U.S. Cl. 429/482; 429/492; 429/493

(57) ABSTRACT

There is used a polymer electrolyte membrane containing a polymer segment (A) having an ion-conducting component, and a polymer segment (B) having a composition ratio of the ion-conducting component lower than that in the polymer segment (A), wherein the polymer segment (A) and the polymer segment (B) form a micro phase-separated structure, and inorganic particles 8 (a metal oxide, the metal oxide supporting a sulfuric acid ion, a metal hydroxide, the metal hydroxide supporting a sulfuric acid ion, a metal salt of phosphoric acid, and a metal fluoride or carbon) are present in a hydrophilic domain 9 composed of the polymer segment (A), in higher concentration than that in a hydrophobic domain 10 composed of the polymer segment (B).

### BACKGROUND OF THE INVENTION

The present invention relates to a polymer electrolyte fuel cell.

As a polymer electrolyte membrane for fuel cells, a fluorine-based electrolyte membrane having high proton conductivity, such as Nafion (registered trade name, produced by DuPont Co., Ltd.), Aciplex (registered trade name, produced by Asahi Kasei Chemicals Co., Ltd.), Flemion (registered trade name, produced by Asahi glass Co., Ltd.) has been known, however, the fluorine-based electrolyte membrane is very expensive. In addition, hydrofluoric acid generates in incineration for disposal treatment. Still more, there is a problem of inability to be used at a high temperature of 100° C. or higher, due to decrease in ion conductivity. In addition, in the case of using it as an electrolyte membrane for direct methanol fuel cells (hereafter may be referred to as DMFC), there is a problem of decrease in voltage, or decrease in power generation efficiency caused by methanol crossover.

Accordingly, as the polymer electrolyte membrane for fuel cells, there has been proposed a hydrocarbon-based polymer electrolyte membrane composed of a cheap polyether sulfone-based or a polyether ketone-based polymer, as described in JP-A-2003-31232 or JP-A-2006-512428, other than the fluorine-based electrolyte.

By the way, power generation under low humidity is required to enhance the efficiency of the fuel cells, however, the electrolyte membrane had a problem that the proton conductivity decreases under low humidity environment as compared with high humidity environment. It has been known that the proton conductivity becomes high when the amount of water contained in the electrolyte membrane is high, and thus it is considered that the proton conductivity decreases under the low humidity environment, because the amount of water contained in the electrolyte membrane is low.

There has been disclosed in JP-A-7-90111, a technology to enhance power generation performance by adding a sulfuric acid supported metal oxide to the electrolyte membrane, so as to enhance the proton conductivity of the electrolyte membrane.

However, effect of on proton conductivity by these was not necessarily large, and there was a problem of decrease in mechanical strength of the electrolyte membrane, caused by inputting a large quantity of the additives.

There have been described in JP-1-52866 a measurement method by acid-base titration, non-aqueous acid-base titration (using a benzene-methanol solution of potassium methoxide as a normal solution) and the like.

There has been disclosed in JP-A-2009-252471 a preparation method for a block copolymer having a hydrophobic segment and a hydrophilic segment.

There has been disclosed in JP-A-2006-273890 an anisotropic ion-conducting polymer membrane containing an amphiphilic polymer, which is a block copolymer where a hydrophilic polymer component and a hydrophobic polymer component are bound by a covalent bond, having a cylinder consisting of the hydrophilic polymer oriented unidirectionally in a membrane, and containing a metal oxide.

There has been disclosed in JP-A-2008-311226 a composite polymer electrolyte membrane containing a block copolymer consisting of a hydrophilic block and a hydrophobic block, and a sold acid, having a micro phase-separated structure consisting of a hydrophilic domain formed by the hydrophilic block, and a hydrophobic domain formed by the hydrophobic block, wherein the acid is localized in the hydrophilic domain. As a specific example of the solid acid to be used in this composite polymer electrolyte membrane, there are included phosphoric heteropoly acid, silica, zirconium phosphate, zirconium sulfate, titanic, a cesium salt such as CsHSO₄, CsH₂SO₄, Ce₂(HSO₄)(H₂PO₄), or the like.

There has been disclosed in JP-A-2005-216667 a composite membrane of a polymer electrolyte filled with an ion-exchange resin in voids of a porous substrate composed of polyolefin.

### SUMMARY OF THE INVENTION

It is an object of the present invention to provide a low price polymer electrolyte membrane having superior mechanical characteristics and oxidation resistance in fuel cells, and high power fuel cells.

The polymer electrolyte membrane of the present invention is characterized by containing a polymer segment (A) having an ion-conducting component, and a polymer segment (B) having a composition ratio of the ion-conducting component lower than that in the polymer segment (A), wherein the polymer segment (A) and the polymer segment (B) form a micro phase-separated structure, and in a hydrophilic domain composed of the polymer segment (A), a metal oxide, the metal oxide supporting a sulfuric acid ion, a metal hydroxide, the metal hydroxide supporting a sulfuric acid ion, a metal salt of phosphoric acid, and a metal fluoride or carbon are present in a higher concentration than that in a hydrophobic domain composed of the polymer segment (B).

According to the present invention, a low price polymer electrolyte membrane having superior mechanical characteristics or high proton conductivity under low humidity (60% or lower), and fuel cells having high power and long lifetime can be provided.

### BRIEF DESCRIPTION OF THE DRAWINGS

FIG. 1 is a schematic configuration drawing illustrating a polymer electrolyte membrane according to an Example.

FIG. 2 a schematic cross-sectional view illustrating a membrane electrode assembly (MEA) using a polymer electrolyte membrane according to an Example.

FIG. 3 is an exploded perspective view illustrating a fuel cell according to an Example.

FIG. 4 is a graph showing analysis results of a titanium compound contained in a polymer electrolyte membrane according to an Example, using an X-ray photoelectron spectroscopy.

### DETAILED DESCRIPTION OF THE INVENTION

The present invention relates to a fuel cell, in particular, a polymer electrolyte membrane to be used in the polymer electrolyte fuel cell (PEFC), and the direct methanol fuel cell (DMFC) which is a kind of the polymer electrolyte fuel cell.

The present inventors have intensively studied on the electrolyte membrane for the polymer electrolyte fuel cell, and as a result, have acquired knowledge that the proton conductivity is superior even under the low humidity environment, in the electrolyte membrane containing a polymer segment (A) having an ion-conducting component, and a polymer segment (B) having a composition ratio of the ion-conducting component lower than that in the polymer segment (A), wherein the polymer segment (A) and the polymer segment (B) form a micro phase-separated structure in said membrane, and in a domain composed of the polymer segment (A), a metal oxide, the metal oxide supporting a sulfuric acid ion, the metal oxide having a modification group at the surface, a metal hydroxide, the metal hydroxide supporting a sulfuric acid ion, the metal hydroxide having a modification group at the surface, or carbon are present in higher concentration than that in a domain composed of the polymer segment (B).

Explanation will be given below on the polymer electrolyte membrane relevant to one embodiment of the present invention, along with the membrane electrode assembly, the polymer electrolyte fuel cell and the direct methanol fuel cell using the same.

The polymer electrolyte membrane is characterized by containing a polymer segment (A) having an ion-conducting component, and a polymer segment (B) having a composition ratio of the ion-conducting component lower than that in the polymer segment (A), wherein the polymer segment (A) and the polymer segment (B) form a micro phase-separated structure, and in a hydrophilic domain composed of the polymer segment (A), a metal oxide, the metal oxide supporting a sulfuric acid ion, a metal hydroxide, the metal hydroxide supporting a sulfuric acid ion, a metal salt of phosphoric acid, and a metal fluoride or carbon are present in higher concentration than that in a hydrophobic domain composed of the polymer segment (B).

In the polymer electrolyte membrane, the metal contained in the metal oxide, the metal hydroxide, the metal salt of phosphoric acid, and the metal fluoride is an oxide, a hydroxide, a salt of phosphoric acid, or a fluoride of Ti, Zr, Nb, W, Sn, Fe, Si, Pb, Al, Mo, Ce, Cr, or Co. That is, the metal contained in the metal oxide, the metal hydroxide, the metal salt of phosphoric acid, and the metal fluoride is Ti, Zr, Nb, W, Sn, Fe, Si, Pb, Al, Mo, Ce, Cr, or Co.

The polymer electrolyte membrane is the one obtained by impregnating aromatic hydrocarbon-based electrolyte in a porous material.

The polymer electrolyte membrane has an ion-exchange capacity of 0.3 to 5.0 meq/g.

The polymer electrolyte membrane contains polyether sulfone having a sulfonic acid group.

Ion-exchange capacity here means the number of ion-exchange groups per unit weight of a polymer, and a larger value indicates a larger introduction degree of the ion-exchange group. The ion-exchange capacity may be measured by ¹H-NMR spectroscopy, elemental analysis, acid-base titration described in JP-1-52866, non-aqueous acid-base titration (using a benzene-methanol solution of potassium methoxide as a normal solution) and the like.

The ion-exchange capacity smaller than 0.3 meq/g decreases the output power caused by an increase in the resistance of the electrolyte membrane in power generation using the fuel cell, while the ion-exchange capacity over 5.0 meq/g may lower mechanical characteristics, and the both are not preferable. Therefore, it is preferable that the ion-exchange capacity is 0.3 to 5.0 meq/g to obtain an electrolyte membrane having superior mechanical characteristics, as well as to attain a high power of the polymer electrolyte fuel cell.

In addition, the micro phase-separated structure in the polymer electrolyte membrane means a phase-separated structure, by the presence of a domain having a higher amount of the ion-conducting component, and a domain having a lower amount of the ion-conducting component. As an evaluation method for the micro phase-separated structure, there is an observation method using a transmission electron microscope; an observation method using a transmission electron microscope after ion-exchanging a proton of a sulfonic acid group with a metal such as Na, K, Rb, Cs, Pb; an observation method using a scanning transmitting electron microscope; an observation method using a scanning transmitting electron microscope after ion-exchanging a proton of the sulfonic acid group with a metal such as Na, K, Rb, Cs, Pb; a surface observation method by evaluating a difference of modulus between a domain having a higher amount of ion-conducting component, and a domain having a lower amount of ion-conducting component, using an atomic force microscope; or the like.

The membrane electrode assembly contains the polymer electrolyte membrane, an anode electrode and a cathode electrode, and the polymer electrolyte membrane has a configuration sandwiched between the anode electrode and the cathode electrode.

The polymer electrolyte fuel cell uses the membrane electrode assembly.

The direct methanol fuel cell uses the membrane electrode assembly.

As a polymer material to be used in the polymer electrolyte membrane includes, for example, a sulfonated engineering plastic-based electrolyte, a sulfo-alkylated engineering plastic-based electrolyte, a hydrocarbon-based electrolyte, and a hydrocarbon-based polymer introduced with a proton conductivity furnishing group and an oxidation resistance furnishing group, and a substitution group may be added thereto.

An example of the sulfonated engineering plastic-based electrolyte includes sulfonated polyketone, sulfonated polysulfone, sulfonated polyphenylene, sulfonated polyether ether ketone, sulfonated polyether sulfone, sulfonated polyether ketone, sulfonated polyimide, sulfonated polybenzimidazole, sulfonated polyquinoline, sulfonated poly(acrylonitrile-butadiene-styrene), sulfonated polysulfide, and sulfonated polyphenylene. An example of the sulfo-alkylated engineering plastic-based electrolyte includes sulfo-alkylated polyether ether ketone, sulfo-alkylated polyether sulfone, sulfo-alkylated polyether ether sulfone, sulfo-alkylated polysulfone, sulfo-alkylated polysulfide, sulfo-alkylated polyphenylene, and sulfo-alkylated polyether ether sulfone. An example of the hydrocarbon-based electrolyte includes sulfo-alkyl etherated polyphenylene.

The metal oxide, the metal hydroxide, the metal salt of phosphoric acid, the metal fluoride and carbon in the polymer electrolyte membrane is not especially limited. One kind selected from these may be used alone, or two or more kinds may be used in combination. Among these, as the metal oxide, an oxide of Ti, Zr, Nb, W, Sn, Fe, Si, Pb, Al, Mo, Ce, Cr, Co or the like is desirable. As the metal salt of phosphoric acid, a salt of phosphoric acid of Ti, Zr, Nb, W, Sn, Fe, Si, Pb, Al, Mo, Ce, Cr, Co or the like is desirable. As the metal fluoride, a fluoride of Ti, Zr, Nb, W, Sn, Fe, Si, Pb, Al, Mo, Ce, Cr, Co or the like is suitable.

Although carbon here is not especially limited, an activated carbon, an amorphous carbon, a graphite, a carbon nanotube and the like are included.

Still more, the electrolyte here includes polyperfluorosulfonic acid, other than the sulfonated engineering plastic.

In addition, the number average molecular weight of a polymer material to be used for the polymer electrolyte membrane is 10000 to 250000 g/mol, as the number average molecular weight converted to polystyrene, determined by a GPC method. It is preferably 20000 to 220000 g/mol, and still more preferably 25000 to 200000 g/mol. The number average molecular weight smaller than 10000 g/mol decreases the strength of the electrolyte membrane, while the number average molecular weight over 200000 g/mol may decrease the output power performance, and the both cases are not preferable.

The polymer material to be used for the polymer electrolyte membrane is used in a polymer membrane state. As a method for producing the polymer membrane, there are, for example, a solution casting method for film-forming from a solution state; a melt press method; and a melt extrusion method. Among these, the solution casting method is preferable, and for example, film-formation is performed by the cast-coating of the polymer solution onto a substrate and then removing the solvent.

A solvent to be used in this film-formation method is not especially limited, as long as it is capable of being removed after dissolving the polymer material, and there are included, for example, an aprotic polar solvent, alkylene glycol monoalkyl ether, an alcohol, and tetrahydrofuran.

As an example of the aprotic polar solvent, there are included N,N-dimethylformamide, N,N-dimethylacetamide, N-methyl-2-pyrrolidone and dimethylsulfoxide. As an example of the alkylene glycol mono-alkyl ether, there are included ethylene glycol mono-methyl ether, ethylene glycol mono-ethyl ether, propylene glycol mono-methyl ether, and propylene glycol mono-ethyl ether. As an example of the alcohol, there are included iso-propyl alcohol, and t-butyl alcohol.

In producing the polymer electrolyte membrane, additives such as a plasticizer, an antioxidant, a peroxide decomposition catalyst, a metal scavenger, a surfactant, a stabilizer, a mold releasing agent and a porous substrate, which are used in a usual polymer, may be used within a range not to impair an object of the present invention.

As the antioxidant, there are included, for example, an amine-based antioxidant, a phenol-based antioxidant, a sulfur-based antioxidant and a phosphorus-based antioxidant.

As an example of the amine-based antioxidant, there are included phenol-α-naphthyl amine, phenol-β-naphthyl amine, diphenylamine, p-hydroxydiphenyl amine and phenothiazine. As an example of the phenol-based antioxidant, there are included 2,6-di(t-butyl)-p-cresol, 2,6-di(t-butyl)-p-phenol, 2,4-dimethyl-6-(t-butyl)-phenol, p-hydroxyphenylcyclohexane, di-p-hydroxyphenylcyclohexane, styrenated phenol and 1,1′-methylenebis(4-hydroxy-3,5-di-t-butylphenol). As an example of the sulfur-based antioxidant, there are included dodecylmercaptan, dilauryl thiodipropionate, distearyl thiodipropionate, dilauryl sulfide and mercaptobenzimidazol. As an example of the phosphorus-based antioxidant, there are included trinonyl phosphite, trioctadecyl phosphite, tridecyl phosphite and trilauryl trithiophosphite.

The peroxide decomposition catalyst is not especially limited, as long as it has catalytic action to decompose the peroxide, and there are included, for example, a metal, the metal oxide, the metal salt of phosphoric acid, the metal fluoride, a large-cyclic metal complex, other than the above antioxidant. One kind selected from these may be used alone, or two or more kinds may be used in combination.

As the metal, Ru, Ag and the like are desirable. As the metal oxide, RuO, WO₃, CeO₂, Fe₃O₄ or the like is desirable. As the metal phosphate, CePO₄, CrPO₄, AIPO₄, FePO₄ and the like are desirable. As the metal fluoride, CeF₃, FeF₃ and the like are desirable. As the large-cyclic metal complex, Fe-porphyrin, Co-porphyrin, heme, catalase, and the like are suitable. In particular, it is preferable to use RuO₂ or CePO₄, due to the high decomposition performance of the peroxide.

The metal scavenger is not especially limited, as long as it forms a complex by reacting with a metal ion such as Fe²⁺ or Cu²⁺ to deactivate the metal ion, and to suppress a deterioration promotion action which the metal ion has. As such a metal scavenger, there may be used, for example, thenoyltrifluoroacetone, sodium diethylthiocarbamate (DDTC), 1,5-diphenyl-3-thiocarbazone; a crown ether such as 1,4,7,10,13-pentaoxicyclopentadecane, 1,4,7,10,13,16-hexaoxicyclopentadecane; a cryptand such as 4,7,13,16-tetraoxa-1,10-diazacyclooctadecane, 4,7,13,16,21,24-hexaoxi-1,10-diazacyclohexacosane; and a porphyrin-based material such as tetraphenylporphyrin.

In addition, in producing the polymer electrolyte membrane, the mixing amount of various kinds of materials should not be limited to the amount described in Examples. Among these materials, in particular, use of the phenol-based antioxidant and the phosphorus-based antioxidant in combination is preferable, because of having effect by a small amount, and having a small degree of adverse influence on various characteristics of the fuel cell. These antioxidant, peroxide decomposition catalyst, and metal scavenger may be added to the electrolyte membrane and the electrode, or may be arranged between the electrolyte membrane and the electrode. In particular, arranging them between the electrolyte membrane and the electrode is preferable, because of having effect by a small amount, and having a small degree of adverse influence on various characteristics of the fuel cell.

Although the porous substrate includes a porous thin film made of polyolefin, or polytetrafluoroethylene or the like, it is not especially limited, as long as it is a porous substance.

Although thickness of the polymer electrolyte membrane is not especially limited, it is preferably 10 to 300 μm, and particularly preferably 15 to 200 μm. In order to obtain the membrane strength of a practically endurable membrane, it is preferably thicker than 10 μm, and in order to decrease membrane resistance, that is, to enhance the power generation performance, it is preferably thinner than 200 μm.

In the case of the solution casting method, membrane thickness can be controlled by the solution concentration or by the coating thickness onto a substrate. In the case of film-formation from a molten state, membrane thickness can be controlled by stretching a film with predetermined thickness obtained by the melt press method or the melt extrusion method or the like, in a predetermined magnification.

An electrode catalyst layer is prepared by bonding the polymer electrolyte membrane of the present invention and carbon powder supporting the catalyst, using a polymer electrolyte having proton conductivity. As the polymer electrolyte, a conventional fluorine-based polymer electrolyte or a hydrocarbon-based electrolyte may be used.

In this specification, as the hydrocarbon-based electrolyte, there are included, for example, a sulfonated engineering plastic-based electrolyte, a sulfo-alkylated engineering plastic-based electrolyte, a hydrocarbon-based electrolyte, and a hydrocarbon-based polymer introduced with the above proton conductivity furnishing group and the oxidation resistance furnishing group.

As an example of the sulfonated engineering plastic-based electrolyte, there are included sulfonated polyketone, sulfonated polysulfone, sulfonated polyphenylene, sulfonated polyether ether ketone, sulfonated polyether sulfone, sulfonated polyether ketone, sulfonated polyimide, sulfonated polybenzimidazole, sulfonated polyquinoline, sulfonated poly(acrylonitrile-butadiene-styrene), sulfonated polysulfide and sulfonated polyphenylene. As an example of the sulfo-alkylated engineering plastic-based electrolyte, there are included sulfo-alkylated polyether ether ketone, sulfo-alkylated polyether sulfone, sulfo-alkylated polyether ether sulfone, sulfo-alkylated polysulfone, sulfo-alkylated polysulfide, sulfo-alkylated polyphenylene, and sulfo-alkylated polyether ether sulfone. An example of the hydrocarbon-based electrolyte includes sulfo-alkyl etherated polyphenylene.

As an anode catalyst or a cathode catalyst to be used in the anode electrode or the cathode electrode, any one may be used as long as it is a metal promoting the oxidation reaction of fuel or the reduction reaction of oxygen, and there are included, for example, platinum, gold, silver, palladium, iridium, rhodium, ruthenium, iron, cobalt, nickel, chromium, tungsten, manganese, vanadium, titanium, or an alloy thereof. Among these metals, in particular, platinum (Pt) is used in many cases. The particle diameter of a metal as the catalyst is usually 1 to 30 nm. The catalyst with a smaller particle diameter is advantageous in view of cost, because of requiring a small use amount when adhered onto a carrier such as carbon. The supporting amount of the catalyst is preferably 0.01 to 20 mg/cm² in a state where the electrode is formed.

The electrode to be used in the membrane electrode assembly (polymer electrolyte membrane/electrode assembly: MEA) is composed of a conductive material supported with fine particles of a catalyst metal, and may contain a water repellent or a binder, according to need. In addition, the conductive material not supporting the catalyst, and a layer composed of the water repellent or the binder, contained according to need, may be formed at the exterior side of the catalyst layer.

As the conductive material for supporting the catalyst metal, any one may be used as long as it is an electron conductive substance, and includes, for example, various kinds of metals or a carbon material. As the carbon material, there may be used, for example, carbon black such as furnace black, channel black, acetylene black, a fibrous carbon such as a carbon nanotube, activated carbon, or graphite, and they may be used alone, or two or more kinds may be used in combination.

As the water repellant, for example, fluorinated carbon is used.

As the binder, it is preferable to use a solution mixed with a hydrocarbon electrolyte of the same type as the electrolyte membrane in view of adhesive property, however, other various-types of resins may be used. In addition, a fluorine-containing resin having water-repellent property, for example, polytetrafluoroethylene, a tetrafluoroethylene-perfluoroalkylvinyl ether copolymer, or a tetrafluoroethylene-hexafluoropropylene copolymer may be added.

A method bonding the polymer electrolyte membrane and the electrode in producing a fuel cell is also not especially limited, and known methods may be applied.

As an example of preparation method for the membrane electrode assembly, there is a method of mixing Pt catalyst powder supported on a conductive material (for example, carbon) and a suspension solution of polytetrafluoroethylene, coating it onto a carbon paper, and forming a catalyst layer by heat treatment, and coating a solution of the same polymer electrolyte as the polymer electrolyte membrane, or the fluorine-based electrolyte onto the catalyst layer, as a binder, and making one piece with the polymer electrolyte membrane by hot pressing. In addition to this method, there are a method for coating the solution of the same polymer electrolyte as the polymer electrolyte membrane onto the Pt catalyst powder in advance; a method for coating a catalyst paste onto the polymer electrolyte membrane by a printing method, a spraying method or an inkjet method; a method for electroless-plating an electrode onto the polymer electrolyte membrane; a reducing method after adsorbing platinum group metal complex ions onto the polymer electrolyte membrane; or the like. Among these, the coating method of catalyst paste onto the polymer electrolyte membrane by the inkjet method is superior, because of the small loss of the catalyst.

Using the above polymer material as the electrolyte membrane, various forms of fuel cells can be provided. For example, a single cell of the polymer electrolyte fuel cell can be formed, provided with a polymer electrolyte membrane/electrode assembly, wherein one surface of the main surface of the electrolyte membrane is clamped by oxygen electrodes, and the other one surface is clamped by hydrogen electrodes, gas diffusion sheets installed in close contact with each electrode separately at each of the oxygen electrode side and the hydrogen electrode side, and an electric conductive separator having gas supply passages to the oxygen electrode and the hydrogen electrode at each exterior surface of each gas diffusion sheet.

In addition, a potable power source can be provided, which has inside a case, a main body of the above fuel cell and a hydrogen cylinder for storing hydrogen to be supplied to this main body of the fuel cell.

Still more, a fuel cell power generation apparatus can be provided, which is provided with a reforming device for reforming an anode gas containing hydrogen, a fuel cell for generating power from this anode gas and cathode gas containing oxygen, and a heat exchanger for exchanging heat between the high temperature anode gas discharged from the reforming device and the low temperature fuel gas supplied to the reforming device.

In addition, a single cell of the direct methanol fuel cell can be formed, which is provided with a polymer electrolyte membrane/electrode assembly, wherein one surface of the main surface of the electrolyte membrane is clamped by oxygen electrodes, and the other one surface is clamped by hydrogen electrodes, gas diffusion sheets installed in close contact with each electrode separately at each of the oxygen electrode side and the hydrogen electrode side, and an electric conductive separator having a gas and liquid supply passage to the oxygen electrode and a methanol electrode at each exterior surface of each gas diffusion sheet.

Explanation will be given below in more detail with reference to Examples, however, the gist of the present invention should not be limited to the following Examples.

### Example 1

### (1) Preparation of the Polymer Electrolyte Membrane (Solid Polymer Electrolyte Membrane)

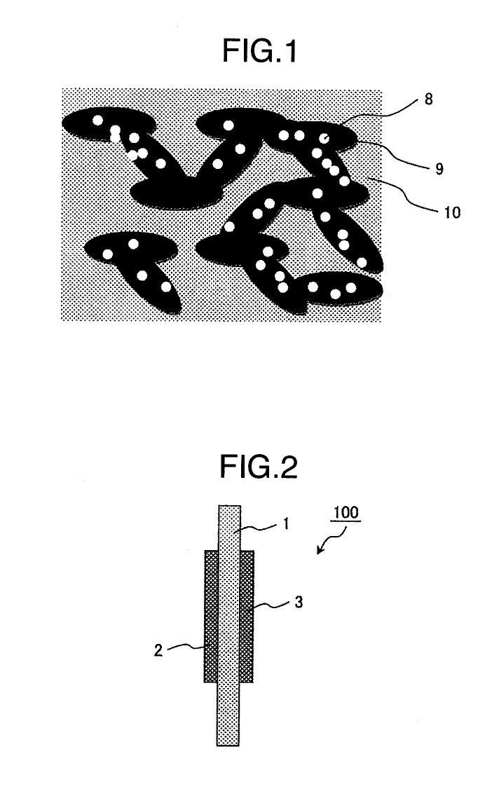

FIG. 1 is a schematic configuration drawing illustrating the polymer electrolyte membrane.

In this drawing, hydrophilic domains 9 are dispersed in a hydrophobic domain 10. In addition, inorganic particles 8 are dispersed in the hydrophilic domains 9.

An electrolyte membrane (polymer electrolyte membrane) illustrated in this drawing was prepared.

A sulfonated polyether sulfone block-copolymer having an ion-exchange capacity of 2.0 meq/g, and a number average molecular weight (Mn) of 12×10⁵ g/mol was prepared using a method disclosed in JP-A-2009-252471. It was named as an electrolyte A. The electrolyte A was dissolved in N-methyl-2-pyrrolidone (NMP) containing 5% by weight of tetraethoxytitanium (IV), so as to attain a concentration of 15% by weight to prepare a solution of the electrolyte A. Because tetraethoxytitanium (IV) reacts with water adsorbed to sulfonic acid of the electrolyte A, and is hydrolyzed to obtain a white solution.

Next, the solution of the electrolyte A was coated on a surface of a glass substrate, and then dried by heating. Next, after it was impregnated into a 0.1 mol/l aqueous solution of sodium hydroxide, and then impregnating it in 1 mol/L sulfuric acid and water, and drying it, a 40 μm thick polymer electrolyte membrane was prepared.

The measurement condition for GPC (Gel Permeation Chromatography) used in measurement of the number average molecular weight was as follows.

GPC apparatus: HLC-8220GPC, manufactured by Tosoh Corp.

Column: two pieces of TSK gel Super AWM-H, manufactured by Tosoh Corp.

Eluate: N-methyl-2-pyrrolidone (NMP, added with 10 mmol/L of lithium bromide)

A micro phase-separated structure was observed with a scanning transmitting electron microscope (HD-2000, manufactured by Hitachi High Technologies Co., Ltd.), by slicing the polymer electrolyte membrane of the present Example using cryogenic microtome (EM FC6, manufactured by Leica Co., Ltd.), after ion-exchanging a proton of the sulfonic acid group of the polymer electrolyte membrane of the present Example with Cs. For the elemental analysis, an energy dispersive X-ray fluorescence spectrometer (EDX) equipped with a scanning transmitting electron microscope (Genesis, manufactured by EDAX Co., Ltd.) was used.

As a result, it has been confirmed that the polymer electrolyte membrane of the present Example has a micro phase-separated structure containing the polymer segment (A) having an ion-conducting component, and the polymer segment (B) not having the ion-conducting component or having a composition ratio of the ion-conducting component lower than that in the polymer segment (A).

A titanium compound contained in the polymer electrolyte membrane of the present Example was identified by evaluation of an electronic state of Ti using an X-ray photoelectron spectrometry (XPS).

An apparatus used is AXIS-HS, manufactured by Shimadzu Corp./KRATOS. The measurement condition was as follows: X-ray source: monochrome Al, X-ray output power: 15 kV-15 mA, resolution: Pass energy 40, and scanning speed: 20 eV/min. A state of the titanium compound was evaluated using the 2p electron.

FIG. 4 is a graph representing a result thereof. The X-axis represents binding energy, and the Y-axis represents intensity.

From this drawing, it has been understood that the titanium compound does not correspond to any of TiO₂, TiO and Ti. That is, it has been understood that it is different from an electronic state of only TiO₂, that is, it is not present in the polymer electrolyte membrane as only TiO₂, but as a mixed state of a metal oxide other than TiO₂, or a metal hydroxide (a titanium compound derived from tetraethoxytitanium (IV)).

In addition, it has been confirmed from the elemental analysis that Ti is present in higher concentration in the polymer segment (A) than in the polymer segment (B). Ti was in a state of a metal oxide or a metal hydroxide in the polymer electrolyte membrane.

Proton conductivity of the polymer electrolyte membrane of the present Example was measured at 80° C., under 60% RH, using a method described in Polymer Vol. 49, Issue 23 (2008), 5037, and was found to be 0.08 S/cm.

### (2) Preparation of the Membrane Electrode Assembly (MEA)

FIG. 2 is a cross-sectional view of the MEA.

In this drawing, the membrane electrode assembly 100 contains a polymer electrolyte membrane 1, an anode electrode 2 and a cathode electrode 3, and the polymer electrolyte membrane 1 has a configuration sandwiched between the anode electrode 2 and the cathode electrode 3.

The membrane electrode assembly 100 (MEA) illustrated in this drawing was prepared.

A slurry was prepared by mixing catalyst powder supported and dispersed with 70% by weight of platinum fine powder on the surface of a carbon carrier, and 5% by weigh of polyperfluorosulfonic acid, into a mixed solvent composed of 1-propanol, 2-propanol and water. This slurry was spray coated onto the surface of the polymer electrolyte membrane 1, so as to attain a catalyst weight of 0.4 g/cm², to prepare a cathode electrode 3 and an anode electrode 4, having a thickness of about 20 μm, a width of 30 mm and a length of 30 mm.

On one surface of the polymer electrolyte membrane 1, the cathode electrode 3 was arranged, and on the other surface, the anode electrode 2 was arranged, and they were hot pressed at 120° C. under 13 MPa. In this way, the membrane electrode assembly 100 (MEA) illustrated in this drawing was prepared.

### (3) Preparation of the Polymer Electrolyte Fuel Cell (PEFC) and Power Generation Performance thereof

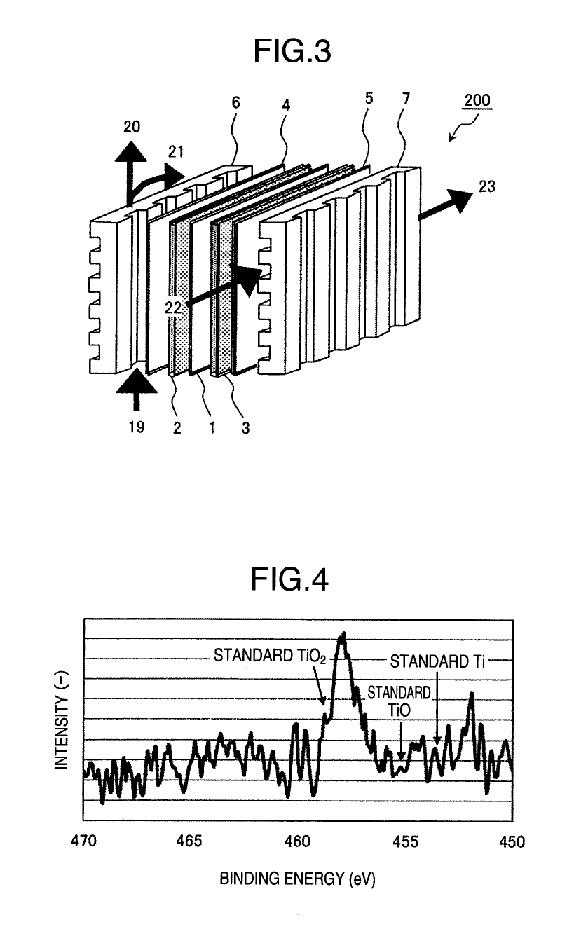

FIG. 3 is an exploded perspective view illustrating an internal structure of the fuel cell of an Example.

In the present drawing, the fuel cell 200 is composed of a polymer electrolyte membrane 1, an anode electrode 2, a cathode electrode 3, an anode diffusion layer 4, a cathode diffusion layer 5, an anode side separator 6 and a cathode side separator 7. A single cell of the polymer electrolyte fuel cell 200 is formed by making these compositional elements closely adhered.

The MEA is the same MEA as illustrated in FIG. 2, and is composed of the polymer electrolyte membrane 1, the anode electrode 2 and the cathode electrode 3.

As illustrated in FIG. 3, hydrogen 19 is flown in a fuel passage of the anode side separator 6, and air 22 is flown in an air passage of the cathode side separator 7. On removal of an electron (oxidation) in the process of passing through the fuel passage, the hydrogen 19 becomes a proton (H⁺) and diffuses inside the polymer electrolyte membrane 1, reacts with oxygen contained in the air 22 passing through the air passage to become water 21. The water 21 and a reaction residue 20 (hydrogen and steam) are both discharged to outside of the single cell. In addition, the air 22 becomes air 23 containing steam to be discharged to outside of the single cell.

A power generation test was performed using a small size single cell illustrated in the present drawing, to measure the power generation performance of the polymer electrolyte fuel cell using the above MEA.

In this measurement, by installing the single cell in a constant temperature chamber, the temperature of the constant temperature chamber was controlled, so as to set the temperature of a thermocouple (not shown) installed inside the anode side separator 6 and the cathode side separator 7 at 70° C.

The anode electrode 2 and the cathode electrode 3 were humidified using a humidifier installed exterior of the single cell, and the temperature of the humidifier was controlled at between 70 to 73° C., so as to set the dew point at 80° C. in the vicinity of the exit of the humidifier. Power generation was performed under the conditions of a load current density of 250 mA/cm², a hydrogen utilization rate of 70%, and an air utilization rate of 40%. As a result, it has been understood that the output power of the above single cell indicated 0.75 V or higher, and it was found that stable power generation is possible.

### Example 2

### (1) Preparation of the Polymer Electrolyte Membrane (Solid Polymer Electrolyte Membrane)

The electrolyte A described in Example 1 was dissolved in N-methyl-2-pyrrolidone (NMP) containing 5% by weight of tetraethoxytitanium (IV), so as to attain a concentration of 15% by weight to prepare the solution of the electrolyte A. Because tetraethoxytitanium (IV) reacts with water adsorbed to sulfonic acid of the electrolyte A, and is hydrolyzed to obtain a white solution. Next, the solution of the electrolyte A was coated on the surface of a glass substrate, and then dried by heating. Next, after it was impregnated into a 0.1 mol/l aqueous solution of sodium hydroxide, impregnating it in 3 mol/L sulfuric acid and water, and drying it, a 40 μm thick polymer electrolyte membrane was prepared.

A micro phase-separated structure was observed with the scanning transmitting electron microscope (HD-2000, manufactured by Hitachi High Technologies Co., Ltd.), by slicing this polymer electrolyte membrane using the cryogenic microtome (EM FC6, manufactured by Leica Co., Ltd.), after ion-exchanging a proton of the sulfonic acid group of the polymer electrolyte membrane with Cs. For the elemental analysis, the energy dispersive X-ray fluorescence spectrometer (EDX) equipped with the scanning transmitting electron microscope (Genesis, manufactured by EDAX Co., Ltd.) was used.

As a result, it has been confirmed that the polymer electrolyte membrane of the present Example has a micro phase-separated structure containing the polymer segment (A) having an ion-conducting component, and the polymer segment (B) not having the ion-conducting component, or having composition ratio of the ion-conducting component lower than that in the polymer segment (A).

The Ti oxide, obtained by firing the polymer electrolyte membrane of the present Example at 300° C., was subjected to the EDX analysis.

As a result, S was ascertained at the surface, by which it was understood that the titanium compound present in the polymer electrolyte membrane of the present Example is a mixture of sulfated titanium bound with a sulfuric acid group (sulfuric acid ion) at the surface, and titanium oxide or titanium hydroxide. That is, the Ti compound in the present Example is the one wherein sulfuric acid ions were supported on Ti oxide or Ti hydroxide.

The proton conductivity of the polymer electrolyte membrane of the present Example was measured at 80° C., under 60% RH, using the method described in Polymer Vol. 49, Issue 23 (2008), 5037, and was found to be 0.08 S/cm.

### Example 3

### (1) Preparation of the Polymer Electrolyte Membrane (Solid Polymer Electrolyte Membrane)

The electrolyte A described in Example 1 was dissolved in N-methyl-2-pyrrolidone (NMP) containing 5% by weight of sulfated zirconia (produced by Wako Pure Chemical Industries, Ltd.), so as to attain a concentration of 15% by weight to prepare the solution of the electrolyte A. Next, the solution of the electrolyte A was coated on the surface of a glass substrate, and then dried by heating. Next, after it was impregnated into a 0.1 mol/l aqueous solution of sodium hydroxide, impregnating it in 1 mol/L, sulfuric acid and water, and drying it, a 40 μm thick polymer electrolyte membrane was prepared.

A micro phase-separated structure was observed with the scanning transmitting electron microscope (HD-2000, manufactured by Hitachi High Technologies Co., Ltd.), by thinning this polymer electrolyte membrane using the cryogenic microtome (EM FC6, manufactured by Leica Co., Ltd.), after ion-exchanging a proton of the sulfonic acid group of the polymer electrolyte membrane with Cs. For the elemental analysis, the energy dispersive X-ray fluorescence spectrometer (EDX) equipped with the scanning transmitting electron microscope (Genesis, manufactured by EDAX Co., Ltd.) was used.

As a result, it was confirmed that there is a higher composition ratio of a polymer segment (A) having an ion-conducting component, on the surface of sulfated zirconia, as compared with the whole membrane, and the sulfated zirconia is present in a higher concentration in the polymer segment (A) than in the polymer segment (B).

The proton conductivity of the polymer electrolyte membrane of the present Example was measured at 80° C., under 60% RH, using the method described in Polymer Vol. 49, Issue 23 (2008), 5037, and was found to be 0.07 S/cm.

### Comparative Example 1

### (1) Preparation of the Polymer Electrolyte Membrane (Solid Polymer Electrolyte Membrane)

The electrolyte A described in Example 1 was dissolved in N-methyl-2-pyrrolidone (NMP), and after adding therein 1% by weight of water, 5% by weight of tetraethoxytitanium (IV) was added. Because tetraethoxytitanium (IV) reacts with water in the solution, and is hydrolyzed to obtain a white solution. Next, the solution was coated on the surface of the glass substrate, and then dried by heating. Next, after it was impregnated into a 0.1 mol/l aqueous solution of sodium hydroxide, impregnating it in 1 mol/L sulfuric acid and water, and drying it, a 40 μm thick polymer electrolyte membrane was prepared.

A micro phase-separated structure of the polymer electrolyte membrane of the present Comparative Example was observed with a similar method as in Example 1.

As a result, it has been confirmed that the polymer electrolyte membrane of the present Comparative Example has a micro phase-separated structure containing the polymer segment (A) having an ion-conducting component, and the polymer segment (B) not having the ion-conducting component, or having a composition ratio of the ion-conducting component lower than that in the polymer segment (A). In addition, from the elemental analysis, it has been confirmed that the Ti concentration of the polymer segment (A) and the polymer segment (B) is equivalent.

The proton conductivity of the polymer electrolyte membrane of the present Comparative Example was measured at 80° C., under 60% RH, using the method described in Polymer Vol. 49, Issue 23 (2008), 5037, and was found to be 0.06 S/cm.

### (2) Preparation of a Membrane Electrode Assembly (MEA)

A membrane electrode assembly was prepared by a similar method as in Example 1.

The MEA of the present Comparative Example is the polymer electrolyte membrane 1 illustrated in FIG. 2 arranged with the anode electrode 2 and the cathode electrode 3.

### (3) Preparation of a Polymer Electrolyte Fuel Cell (PEFC) and Power Generation Performance Thereof

A polymer electrolyte fuel cell was prepared using the MEA of the present Comparative Example by a similar method as in Example 1.

As a result, it has been understood that output power of the single cell is 0.74 V or higher, and it was found that stable power generation is possible.

From the above results, the superiority of Examples 1 to 3 has been confirmed.

The present invention is applicable to the direct methanol fuel cell, or the polymer electrolyte fuel cell and the like.

It should be further understood by those skilled in the art that although the foregoing description has been made on embodiments of the invention, the invention is not limited thereto and various changes and modifications may be made without departing from the spirit of the invention and the scope of the appended claims.

1. A polymer electrolyte membrane comprising a polymer segment (A) having an ion-conducting component, and a polymer segment (B) having a composition ratio of the ion-conducting component lower than that in the polymer segment (A),
wherein the polymer segment (A) and the polymer segment (B) form a micro phase-separated structure, and
wherein a metal oxide, the metal oxide supporting a sulfuric acid ion, a metal hydroxide, the metal hydroxide supporting a sulfuric acid ion, a metal salt of phosphoric acid, and a metal fluoride or a carbon are present in a hydrophilic domain consisting of the polymer segment (A), in higher concentration than that in a hydrophobic domain consisting of the polymer segment (B).

2. The polymer electrolyte membrane according to claim 1, wherein the metal contained in the metal oxide, the metal hydroxide, the metal salt of phosphoric acid or the metal fluoride is Ti, Zr, Nb, W, Sn, Fe, Si, Pb, Al, Mo, Ce, Cr, or Co.

3. The polymer electrolyte membrane according to claim 1, wherein an aromatic hydrocarbon-based electrolyte is impregnated in a porous material.

4. The polymer electrolyte membrane according to claim 1, wherein an ion-exchange capacity is 0.3 to 5.0 meq/g.

5. The polymer electrolyte membrane according to claim 1, comprising polyether sulfone having a sulfonic acid group.

6. A membrane electrode assembly comprising the polymer electrolyte membrane according to claim 1, an anode electrode and a cathode electrode, wherein the polymer electrolyte membrane has a configuration sandwiched between the anode electrode and the cathode electrode.

7. A polymer electrolyte fuel cell wherein the membrane electrode assembly according to claim 6 is used.

8. A direct methanol fuel cell wherein the membrane electrode assembly according to claim 6 is used.
